(19) United States
(12) Patent Application Publication
(10) Pub. No.: US 2012/0104770 A1
(43) Pub. Date: May 3, 2012

(54) REGENERATIVE POWER CHARGING FOR ELECTRICITY GENERATION SYSTEMS

(76) Inventor: Sajan "Joseph" Jacob, Norcross, GA (US)

(21) Appl. No.: 12/915,392

(22) Filed: Oct. 29, 2010

(51) Int. Cl. B60L 11/12; H02P 9/04; H02K 7/18

(52) U.S. Cl. 290/40 B; 290/1 R; 290/50

(57) ABSTRACT

An electricity generation system includes a generator, which comprises a rotor and a stator. Rotation of the rotor relative to the stator causes the generator to generate electricity. The rotational speed of the rotor is proportional to the power of the generated electricity. An excess power monitor is provided for determining when the power of the electricity generated by the generator exceeds a power demand. An energy regenerator is coupled to the excess power monitor. The excess power monitor diverts excess power to the energy regenerator when the power of the electricity generated by the generator exceeds the power demand. The energy regenerator converts the excess power into potential energy. The potential energy is stored in an energy storage coupled to the energy regenerator. The energy regenerator may be an air compressor and the energy storage may be one or more compressed air canister. Alternatively the energy regenerator may be a battery charger and the energy storage may be one or more battery. One or more additional flywheel may be coupled to the rotor of the generator to increase the rotational momentum (kinetic energy) of the rotor.

### TECHNICAL FIELD

The present invention relates generally to electricity generation systems. More particularly, the present invention relates to regenerative power charging for electricity generation systems.

### BACKGROUND OF THE INVENTION

As shown in FIG. 1, a typical electricity generation system 100 includes a generator 102 that converts mechanical energy into electrical energy. Mechanical energy is supplied to the generator 102 by an engine 104, which is physically coupled to the generator 102. The engine 104 may be an internal combustion engine, a turbine engine or any other type of motor that converts energy into mechanical motion. An actuator 106 may be used to supply energy (e.g., in the form of compressed air, gas, water, steam, electricity, etc.) to the engine 104 from an external energy source 108. The actuator 106 may be a valve, nozzle, switch, circuit or other mechanical and/or electrical component that is capable of regulating the flow of energy into the engine 104. The actuator 106 may be controlled by a demand controller 110, which monitors the output power demand by way of a feedback loop. By and large, electricity generation systems 100 are driven by energy from external energy sources. What is needed are systems and methods for driving an electricity generation system 100 using energy that is regenerated from excess power produced by the generator 102.

### SUMMARY OF THE INVENTION

The present invention provides systems and methods for regenerative power charging in an electricity generation system. An electricity generation system includes a generator. The generator comprises a rotor and a stator. Rotation of the rotor relative to the stator causes the generator to generate electricity. The rotational speed of the rotor is proportional to the power of the generated electricity. The inventive system includes an excess power monitor for determining when the power of the electricity generated by the generator exceeds a power demand. The system also includes an energy regenerator coupled to the excess power monitor. The excess power monitor diverts excess power to the energy regenerator when the power of the electricity generated by the generator exceeds the power demand. The energy regenerator converts the excess power into potential energy. The potential energy is stored in an energy storage coupled to the energy regenerator.

The system also includes an engine coupled to the generator for causing the rotor of the generator to rotate. An actuator coupled to the engine supplies input energy to the engine. Furthermore, a demand controller may be included for controlling the actuator to increase or decrease the supply of input energy to the engine depending on the power demand. In certain embodiments, the energy regenerator may be an air compressor, the energy storage may be one or more compressed air canister and the actuator may be a compressed air actuator. In other embodiments, the energy regenerator may be a battery charger, the energy storage may be one or more battery and the actuator may be an electric actuator.

One or more additional flywheel may be coupled to the rotor of the generator to increase the rotational momentum of the rotor. In this manner, the momentum of the rotor is increased and additional excess power can be produced during times of decreased power demand.

### BRIEF DESCRIPTION OF THE DRAWINGS

FIG. 1 is a block diagram illustrating an exemplary prior art electrical generator system.

FIG. 2 is a graph illustrating excess power generation in an exemplary electrical generator system.

FIG. 3 is a block diagram illustrating an exemplary electrical generator system including regenerative power charging, according to certain embodiments of the invention.

FIG. 4 is a block diagram illustrating an exemplary electrical generator system including regenerative power charging, according to certain alternative embodiments of the invention.

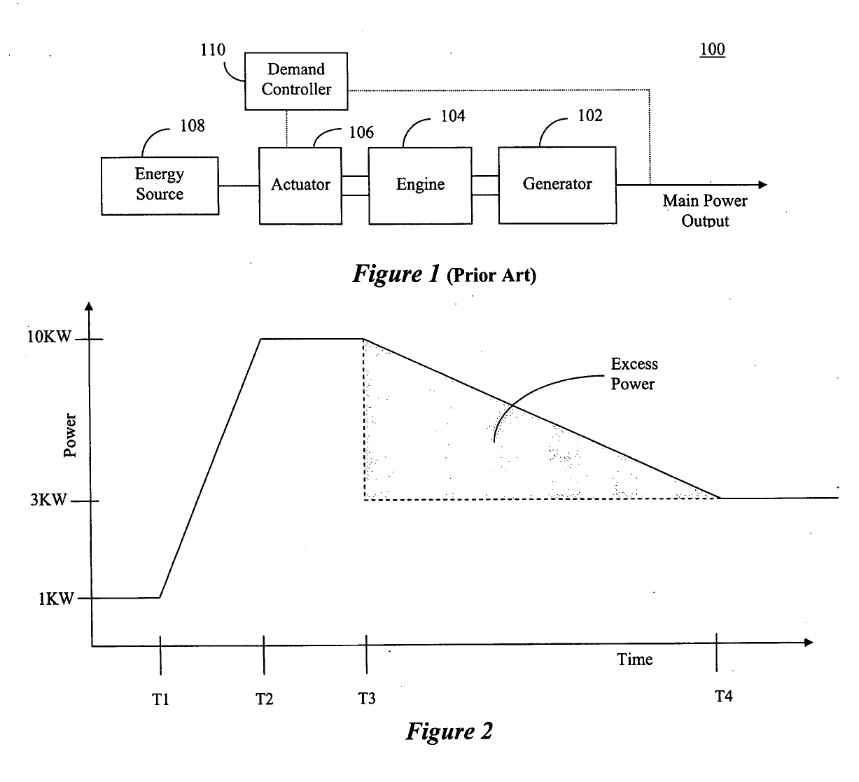

### DETAILED DESCRIPTION OF EXEMPLARY EMBODIMENTS

The present invention provides systems and methods for regenerative power charging in an electricity generation system. As is know in the art, a typical generator 102 has a rotor (rotating part) and a stator (stationary party). In some generators 102, the speed of the rotor is directly proportional to the power output of the generator 102. Thus, as the rotor speed increases, the power output of the generator 102 increases. As the rotor speed decreases, the power output of the generator 102 decreases. However, in many generators 102, changes in rotor speed cannot be effected instantaneously; increases and decreases in rotor speed occur gradually. In particular, a decrease in rotor speed may be achieved simply by removing or decreasing the mechanical energy that causes the rotor to rotate. When the mechanical energy is removed or decreased, the rotor will gradually lose rotational speed due to friction, gravity, etc. While rotor speed gradually decreases, the generator 102 may be generating excess power. This principle is illustrated in FIG. 2.

In the example of FIG. 2, a generator 102 initially outputs 1 KW of power. At time T1 the power demand increases from 1 KW to 10 KW. Therefore, additional mechanical energy is applied to the rotor to increase the rotor speed. At time T2 the rotor speed is sufficient to generate the required 10 KW. Then, at time T3, the power demand decreases from 10 KW to 3 KW and mechanical energy is removed (or reduced) to allow the rotor to slow down. At time T4 the rotor finally settles at the minimum rotational speed required to generate 3 KW. Thus, from time T3 to time T4, the generator 102 generates power in excess of 3 KW. The present invention contemplates capturing and using this excess power, rather than allowing it to go to waste.

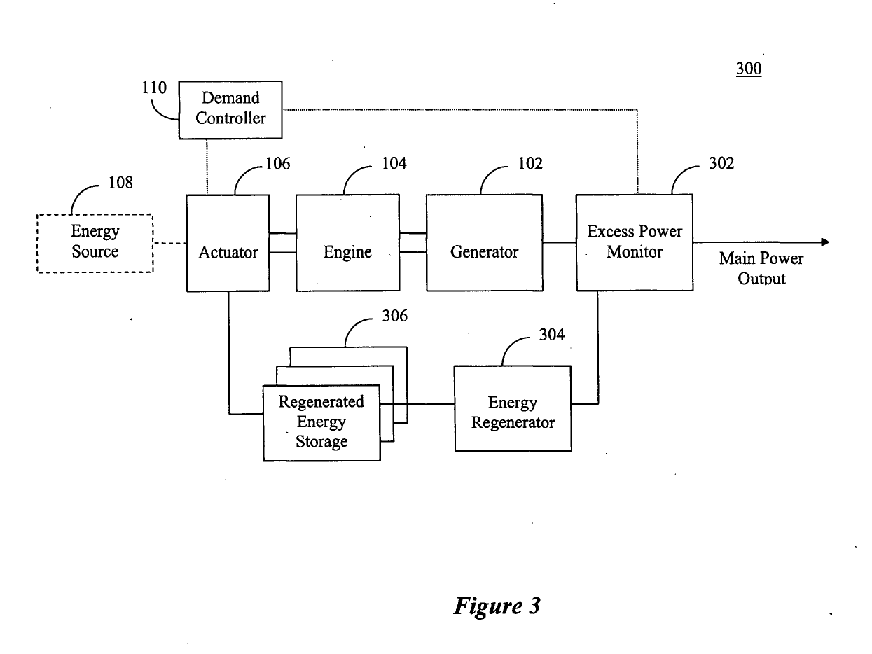

FIG. 3 is a block diagram illustrating an exemplary electricity generation system 300 including regenerative power charging, according to certain embodiments of the invention. As is typical, the system 300 includes a generator 102, engine 104 and actuator 106. The system also includes an excess power monitor 302 for monitoring excess power output by the generator 102. When the generator 102 outputs power that is exceeds demand, the excess power can be diverted to an energy regenerator 304 (e.g., using an electrical switch, breaker or other appropriate circuit). When the generator 102 outputs power that does not exceeds demand, no electrical power flows to the energy regenerator 304.

The energy regenerator 304 may be a battery charger, an air compressor or any other device for generating potential energy from electrical power. The potential energy produced by the energy regenerator 304 is stored in a regenerated energy source 306, which accordingly may be a battery array, compressed air canisters or any other mechanism or medium capable of storing potential energy. The system 300 also include a demand controller 110. When the demand controller 110 detects or is otherwise informed of an increase in the output power demand, it causes the actuator 106 to supply energy from the regenerated energy storage 306 and/or another energy source 108 to the engine 104. In some embodiments, the demand controller 110 may also control the switching mechanism associated with the excess power monitor 302 in order to start/stop the diversion of excess power to the energy regenerator 304.

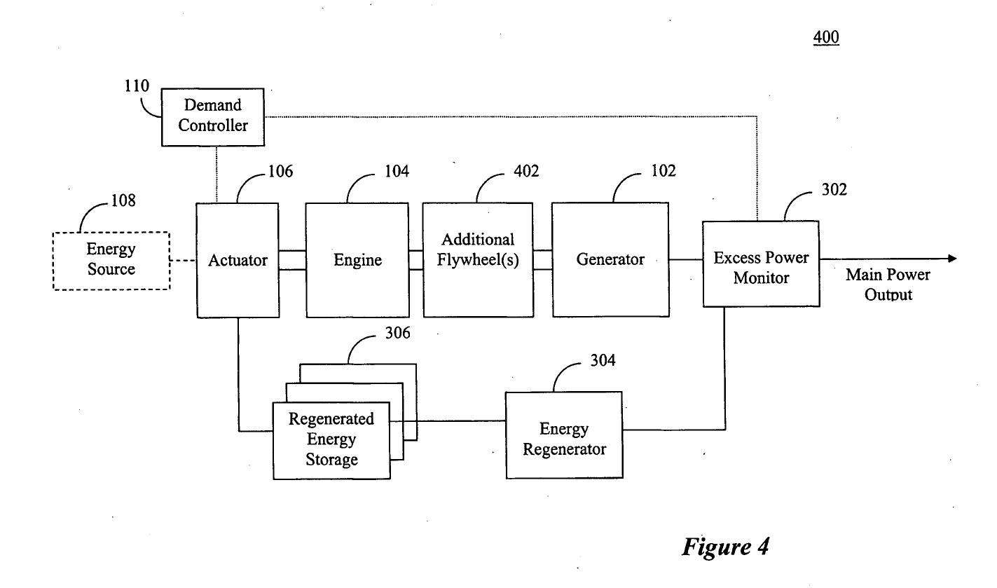

FIG. 4 is a block diagram illustrating an exemplary electricity generation system 400 including regenerative power charging, according to certain alternative embodiments of the invention. Again, the system 400 includes a generator 102, engine 104 and actuator 106. The system 400 also includes a demand controller 110 and an excess power monitor 302 as described with respect to FIG. 3. The system 400 adds one or more additional flywheel(s) 402 between the generator 102 and the engine 104. The additional flywheel(s) 402 may be internal and/or external to the generator 102 and/or the engine 104. The additional flywheel(s) 402 are coupled to the rotor of the generator 102. The added mass and therefore added momentum of the additional flywheel(s) 402 increases the kinetic energy of the rotor during times of decreased power demand. Thus, the additional flywheel(s) 402 will extend the period in which the generator 102 generates excess power (e.g., will extend the time between T3 and T4 in FIG. 2). Therefore, the additional flywheel(s) 402 will increase the amount of excess power that can be generated by the system 400 during normal operation.

The additional flywheel(s) 402 will increase the energy input requirements of the system 400. In other words, more input energy will be needed to put the engine 104 and additional flywheel(s) 402 into motion and to increase their rotational speeds when power demand increases, as compared to the energy needed to actuate the engine 104 alone. The additional input energy may be obtained from the regenerated energy storage 306 and/or another energy source 108. However, in a properly designed system 400, the excess power generated Will exceed the increased input energy requirement.

The foregoing is provided for purposes of illustrating, explaining, and describing embodiments of the present invention. Further modifications and adaptations to these embodiments will be apparent to those skilled in the art. The features and aspects of the present invention have been described or depicted by way of example only and are therefore not intended to be interpreted as required or essential elements of the invention unless otherwise so stated. It should be understood, therefore, that the foregoing relates only to certain exemplary embodiments of the invention, and that numerous changes and additions may be made thereto without departing from the spirit and scope of the invention as defined by any appended claims.

I claim:

1. An electricity generation system, comprising:
a generator comprising a rotor and a stator, wherein rotation of the rotor relative to the stator causes the generator to generate electricity and wherein a rotational speed of the rotor is proportional to a power of the generated electricity;
an excess power monitor for determining when the power of the electricity generated by the generator exceeds a power demand;
an energy regenerator coupled to the excess power monitor, wherein the excess power monitor diverts excess power to the energy regenerator when the power of the electricity generated by the generator exceeds the power demand, and wherein the energy regenerator converts the excess power into potential energy; and
an energy storage coupled to the energy regenerator for receiving and storing the potential energy.

2. The electricity generation system of claim 1, wherein the energy regenerator comprises an air compressor; and
wherein the energy storage comprises one or more compressed air canister.

3. The electricity generation system of claim 1, wherein the energy regenerator comprises a battery charger; and
wherein the energy storage comprises one or more battery.

4. The electricity generation system of claim 1, further comprising:
an engine coupled to the generator for causing the rotor of the generator to rotate;
an actuator coupled to the engine for supplying input energy to the engine; and
a demand controller for controlling the actuator to increase or decrease the supply of input energy to the engine depending on the power demand.

5. The electricity generation system of claim 4, wherein the actuator is coupled to the energy storage.

6. The electricity generation system of claim 5, wherein the energy regenerator comprises an air compressor;
wherein the energy storage comprises one or more compressed air canister; and
wherein the actuator comprises a compressed air actuator.

7. The electricity generation system of claim 5, wherein the energy regenerator comprises a battery charger;
wherein the energy storage comprises one or more battery; and
wherein the actuator comprises an electric actuator.

8. The electricity generation system of claim 1, further comprising at least one additional flywheel coupled to the rotor of the generator to increase the rotational momentum of the rotor.

9. A method for regenerative power charging in an electricity generation system, the method comprising:
monitoring electrical power generated by a generator to determine when the generated electrical power exceeds a power demand;
diverting excess electrical power from a main power output line to an energy regenerator when the electrical power generated by the generator exceeds the power demand, wherein the energy regenerator converts the excess power into potential energy; and
storing the potential energy in an energy storage.

10. The method of claim 10, wherein the energy regenerator comprises an air compressor; and
wherein the energy storage comprises one or more compressed air canister.

11. The method of claim 10, wherein the energy regenerator comprises a battery charger; and
wherein the energy storage comprises one or more battery.

12. The method of claim 10, further comprising:
controlling an actuator to increase or decrease a supply of input energy to an engine that drives the generator, depending on the power demand; and
wherein the actuator is coupled to the energy storage.

13. The method of claim 12, wherein the energy regenerator comprises an air compressor;
wherein the energy storage comprises one or more compressed air canister; and
wherein the actuator comprises a compressed air actuator.

14. The method of claim 12, wherein the energy regenerator comprises a battery charger;
wherein the energy storage comprises one or more battery; and
wherein the actuator comprises an electric actuator.
